(19) United States
(12) Patent Application Publication
(10) Pub. No.: US 2017/0064098 A1
(43) Pub. Date: Mar. 2, 2017

(54) IMAGE TRANSMISSION APPARATUS, IMAGE TRANSMISSION SYSTEM, AND IMAGE TRANSMISSION METHOD

(71) Applicant: Oki Data Corporation, Tokyo (JP)

(72) Inventor: Hideki INOISHI, Tokyo (JP)

(21) Appl. No.: 15/214,518

(22) Filed: Jul. 20, 2016

(30) Foreign Application Priority Data
Aug. 26, 2015 (JP) 2015-166456

(51) Int. Cl. H04N 1/00

(52) U.S. Cl. CPC H04N 1/00106

(57) ABSTRACT

An image transmission apparatus includes: a first address setting unit receiving a setting of a first address as a receiver of information produced with this apparatus body; a second address setting unit for receiving a setting of a second address as an output destination of a transmission result report of the information; and a controller controlling transmission of the information to the first address and output of the transmission result report to the second address.

### CROSS REFERENCE TO RELATED APPLICATIONS

This application claims priority benefits under 35 USC, section 119 on the basis of Japanese Patent Application No. 2015-166456, the disclosure of which is incorporated herein by reference.

### BACKGROUND OF THE INVENTION

### Field of the Invention

This invention relates to an image transmission apparatus, an image transmission system, and an image transmission method.

As shown in FIG. 10, a system structure diagram, a prior art as been known which facsimile transmission is made to an MFP (Multi-Function Peripheral) 5 located at a receiver's place via PSTN (Public Switched Telephone Network) 7 in use of an MFP 3 from a visiting destination.

A user of a mobile terminal device 2 makes facsimile transmission of an original document 1 via the MFP 3 on a LAN (Local Area Network) 4, and the MFP 5 located at the receiver's place outputs images based on the original document 1 as received images 6. The mobile terminal device 2 and the MFP 3 execute the facsimile transmission according to IPP FaxOut Service (PWG 5100.15) set by the PWG (Printer Working Group) via the LAN 4.

Such an MFP executing the facsimile transmission may have a function outputting a transmission result report. The transmission result report contains, e.g., a transmission date, a transmission address, and a transmission result and becomes a proof for facsimile transmission (see, e.g., Japanese Patent Application Publication No. Heisei 06-105,033).

With the prior art, however, the user has to wait for completion of the facsimile transmission to obtain the transmission result report at as visiting destination. In a situation that the workplace with which the user are working does a central management of the transmission result reports, the user has to bring, to the workplace, the transmission result report Obtained at the visiting destination, so that such a handling of the transmission result report makes the user laborious and bothered.

It is therefore an object of the invention to provide an image transmission apparatus allowing a user to receive a transmission result report at a place the user wants and capable of keeping the record on a paper as a proof of facsimile transmission. It is also another object of the invention to provide an image transmission system and an image transmission method, allowing a user to receive a transmission result report at a place the user wants and capable of keeping a record on a paper as a proof of facsimile transmission.

### SUMMARY OF THE INVENTION

According to an aspect of the invention, an image transmission apparatus includes: a first address setting unit receiving a setting of a first address as a receiver of information produced with this apparatus body; a second address setting unit for receiving a setting, of a second address as an output destination of a transmission result report of the information; and a controller controlling transmission of the information to the first address and output of the transmission result report to the second address.

According to another aspect of the invention, an image transmission system having a mobile terminal device, and an image transmission apparatus for transmitting information received from the mobile terminal device to another device, includes the mobile terminal device including a first address setting unit receiving a setting of a first address as a receiver of information produced, and a second address setting unit for receiving a setting of a second address as an output destination of a transmission result report of the information; and the image transmission apparatus including a controller controlling transmission of the information to the first address received from the mobile terminal device and output of the transmission result report to the second address.

In yet another aspect, an image transmission method includes the steps of: processing a first address setting receiving a setting of a first address as a receiver of information; processing a second address setting receiving a setting of a second address as output destination of a transmission result report of the information; and controlling transmission of the information to the first address and output of the transmission result report, to the second address.

### BRIEF DESCRIPTION OF THE DRAWINGS

The foregoing summary, as well as the following detailed description of the invention, will be better understood when read in conjunction with the appended drawings. For the purpose of illustrating the invention there are shown in the drawings embodiments which are presently preferred. It should be understood, however, that the invention is not limited to the precise arrangements and instrumentalities shown. In the drawings:

FIG. 1 is a diagram illustrating connections among an MFP according to an embodiment of the invention, an MFP as a first address serving as a receiver of information produced with the MFP, and an MFP as a second address serving as an output destination of a transmission result report of the information;

FIG. 2 is a block diagram showing a functional structure of the MFP according to the embodiment of the invention;

FIG. 3 is a block diagram showing a structure of a memory unit according to the embodiment of the invention;

FIG. 4 is a flowchart illustrating operation of the MFP according to the embodiment of the invention;

FIG. 5 is an illustration of an address setting screen according to the embodiment of the invention;

FIG. 6 is a diagram illustrating a system structure of an image transmission system formed of a mobile terminal device and the MFP according to a second embodiment of the invention, and also illustrating connections among the system according to the embodiment, an MFP as a first address serving as a receiver of information produced with the mobile terminal device, and an MFP as a second address serving as an output destination of a transmission result report of the information;

FIG. 7 is a flowchart illustrating operation of the MFP according to the second embodiment of the invention;

FIG. 8A, 8B are illustrations of address setting screens according to the second embodiment of the invention;

FIG. 9 is an output example of a transmission result report according to the embodiment of the invention; and

FIG. 10 is a diagram showing a prior art image transmission apparatus.

### DETAILED DESCRIPTION OF EMBODIMENTS

### First Embodiment

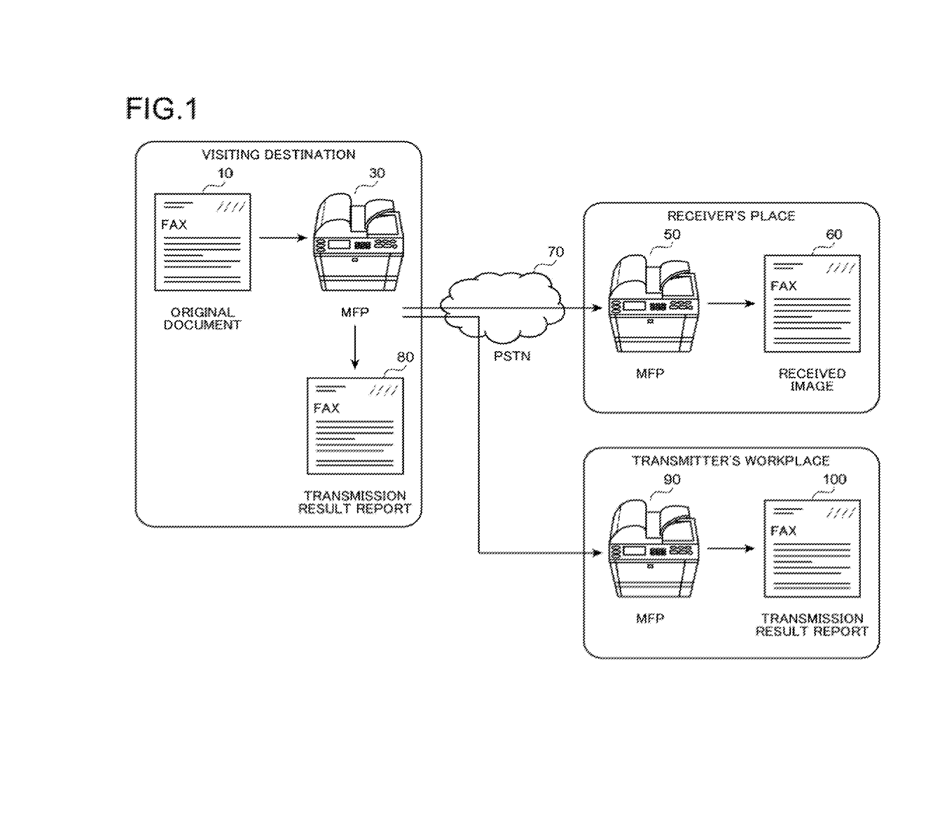

FIG. 1 shows a connection relationship among three MFPs 30, 50, 90. The MFP 30 serves as an image transmission apparatus according to this embodiment; the MFP 50 serves as a first address as the receiver of the information produced at the MFP 30; the MFP 90 serves as a second address as an output destination of a transmission result report of the information. Typically, the MFP 90 is placed at user's (transmitter's) workplace such as, e.g., his office, his house, or any other institutions.

As shown in FIG. 1, the MFP 30 is capable of sending facsimile transmission to the MFP 50 with respect to image data based on an original document 10 read at a reading unit 33 as described below, and capable of outputting a transmission result of the facsimile transmission to the MFP 50. The MFP 30 is further constructed so that a transmission result report 100 can be sent to the MFP 90 as the output destination of the transmission result report of the image data.

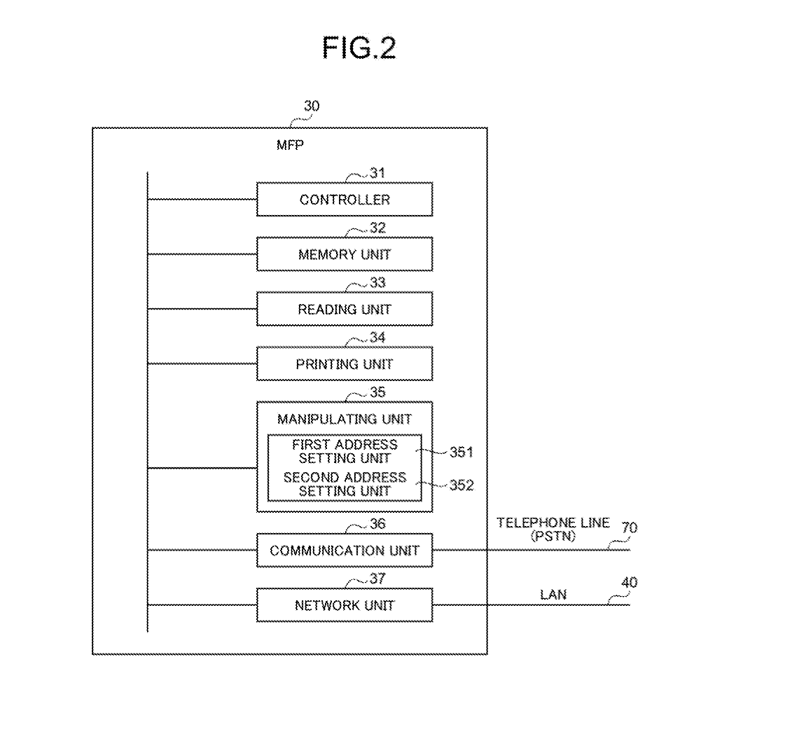

FIG. 2 is a block diagram showing as functional structure of the MFP 30 according to this embodiment. As shown in FIG. 2, the MFP 30 includes a controller 31, a memory unit 32, a reading unit 33, a printing unit 34, a manipulating unit 35, a communication unit 36, and a network unit 37.

The controller 31 is a control device having, e.g., a CPU (Central Processing Unit), and integrally controls the respective portions described below via a system bus.

The memory unit 32 is a memory device utilizing, e.g., ROM (Read Only Memory) and RAM (Random Access Memory) and stores various programs as software executed in the controller 31. The memory unit 32 includes various processing and memory regions as described below, and the controller 31 stores data generated at a time of program executions.

The reading unit 33 is a scanner apparatus utilizing, e.g., a CCD (Charge Couple Device), and has a conversion element converting the read original document 10 into dot images. The dot images converted at the reading unit 33 are stored in the image data memory region 324 described below as image data upon codified with ITU (International Telecommunication Union)-T4 as the facsimile standard.

The printing unit 34 is a printer apparatus of, e.g., a thermographic method or an electrophotographic method, and decodes the received image data and the image data stored in the image data memory region 324 with the standard ITU-T4, thereby outputting the data as a hard copy.

The manipulating unit 35 has a display apparatus such as, e.g., LCD, and displays the apparatus status of the MFP 30, and includes, e.g., a ten key and a start key, required for manipulating the MFP 30. The manipulating unit 35 includes a first address setting unit 351 receiving the setting of the first address (MFP 50) of the image data as the information, and a second address setting unit 352 receiving the setting of the second address (MFP 90) as the output destination of the transmission result report of the image data.

The communication unit 36 is a communication apparatus having an NCU (Network Control Unit) or a modem. The communication unit 36 controls the connection to a telephone line 70, transmits the signal upon modulating digital signal into analog signal in matching the feature of the transmission route, and receives the signal upon demodulating analog signal transmitted from the transmission route to digital signal. The image data and facsimile signal transmitted through the facsimile transmission are transmitted via the communication unit 36. The telephone line 70 corresponds to the PSI 70 described above.

The network unit 37 is referred to as the LAN card and the NIC (Network Interference Card), includes protocols such as, e.g., TCP/IP, and does network communications among the computers via the LAN 40.

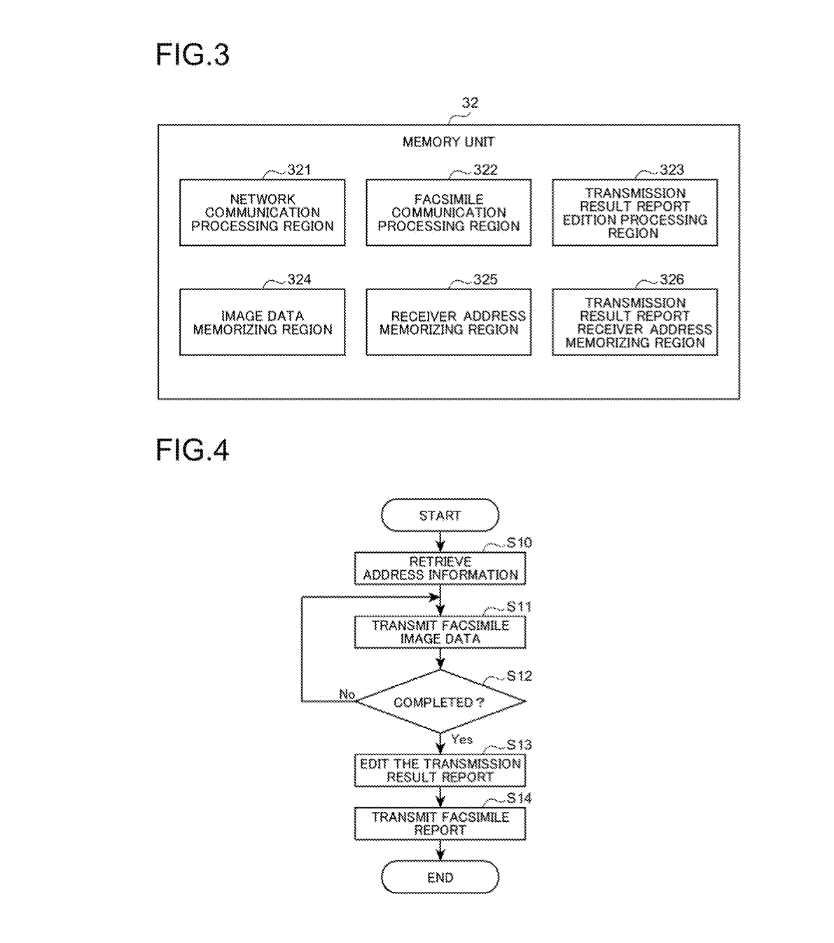

Referring to FIG. 3, a block diagram, the structure of the mentors unit 32 according to this embodiment is shown. A network communication processing region 321 facsimile communication processing region 322, and a transmission result report edition processing region 323, provided in the memory unit 32, are regions memorizing programs executed at the controller 31. An image data memorizing region 324, a receiver address memorizing region 325, and a transmission result report receiver address memorizing region 326 are memory regions memorizing the data generated at the execution time of the programs done by the controller 31.

The controller 31 controls the network unit 37 by executing the programs stored in the network communication processing region 321, thereby making network communication among computers via the LAN 40.

The control 31 executes the programs stored in the facsimile communication processing region 322 to control the communication unit 36, thereby controlling facsimile transmissions between the MFP 30 and the MFP 50 as the receiver of the image data or the MFP 90 as the receiver of the transmission result report via the telephone line 70.

The control unit 31 executes the programs stored in the transmission result report edition processing region 323, thereby editing the output contents to be outputted as the transmission result report.

The image data memorizing region 324 is a memory region memorizing the image data based on the original document 10 read with the reading unit 33 and the edited results of the transmission result reports, and the image data memorized by the image data memorizing unit 324 are sent as facsimile communication to the MFP 50, whereas the transmission result report is sent as facsimile communication to the MFP 90.

The receiver address memorizing region 325 is a memory region memorizing the receiver address information of the image data received via the first address setting. unit 351 of the manipulating unit 35. The receiver address information is data including telephone numbers according to this embodiment. The receiver address information may include, e.g., email address, IPv6 addresses, MAC addresses and any other addresses or accounts for messengers or communications. In this specification, a term of “address” refers to any means to define destination or receiver in communications used by the apparatus, system or method of this invention.

The transmission result report receiver address memorizing region 326 is a memory region memorizing the receiver address information of the transmission result report received via the second address setting unit 352 of the manipulating unit 35.

Next, operation of the image transmission apparatus according to the embodiment is described in referring to a flowchart shown as FIG. 4. This operation is a part of the transmission operation and is executed by the controller 31.

First, at Step S10, the controller 31 retrieves the receiver address information of the image data received via the first address setting unit 351 and the receiver address information of the transmission result report received via the second address setting unit 352, and render the receiver address memorizing region 325 and the transmission result report receiver address memorizing region 326 of the memory unit 32 memorize the information data.

In this embodiment, the image transmission apparatus has a feature that a particular telephone number is judged as the receiver address information of the transmission result report when the particular telephone number is designated as the receiver address information of the transmission result report as the second address.

The image transmission apparatus is exemplified as having a feature that, where a prescribed identifier “*” (asterisk) is designated to be placed at a head oldie telephone number information, the following telephone number is judged as the receiver address information of the transmission result report. The image transmission apparatus or the user may chose any other character or letter as the identifier for the second address, as far as the identifier is already used for other service.

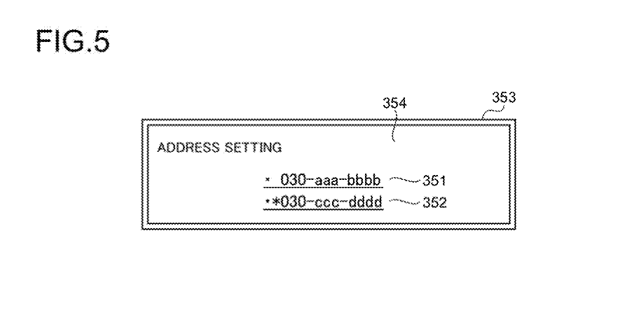

FIG. 5 shows an example of an address setting screen 354 displayed in a display device 353 formed with the manipulating unit 35. As shown in FIG. 5 the user uses a ten key, not shown, of the manipulating unit 35, and enters, e.g., “030-aaa-bbbb” as the telephone number of the MFP 50 for the receiver address information of the image data to the first address setting unit 351. Similarly, the user enters, e.g., “*030-ccc-dddd” having “*” at the head of the telephone number of the MFP 90 as the receiver address information of the transmission result report of the second address setting unit 352. The receiver address information received via the first address setting unit 351 and the second address setting unit 352 is memorized, in the receiver address memorizing region 325 and the transmission result report receiver address memorizing region 326 in the memory unit 32 according to the controller 31.

Returning to FIG. 4, the controller 31 executes facsimile transmission of the image data stored in the image data memorizing region 324 to the address, or namely, the MFP 50 stored in the receiver address memorizing region 325 (Step S11).

The controller 31 repeats the processings until the completion of the .facsimile transmission of the all image data to the MFP 50, and when it is completed (Step S12 Yes), the controller 31 edits the output contents to be outputted as the transmission result report by executing the program stored in the transmission result report edition processing region 323 (Step S13). More specifically, the controller 31 edits the transmission result report to be dot image data and the transmission result report is memorized in the image data memorizing region 324 after encoding the data according to such as the ITU-4U standard.

The controller 31 makes facsimile transmission of the transmission result report stored in the image data memorizing unit 324 to the address, or namely the MFP 90, stored in the transmission result report receiver address memorizing region 326 by controlling the communication unit 36 (Step S14).

### Second Embodiment

Mine transmission system including, a mobile terminal device 20 used by a user at a visiting destination and as MFP 30′ according to a second embodiment is described.

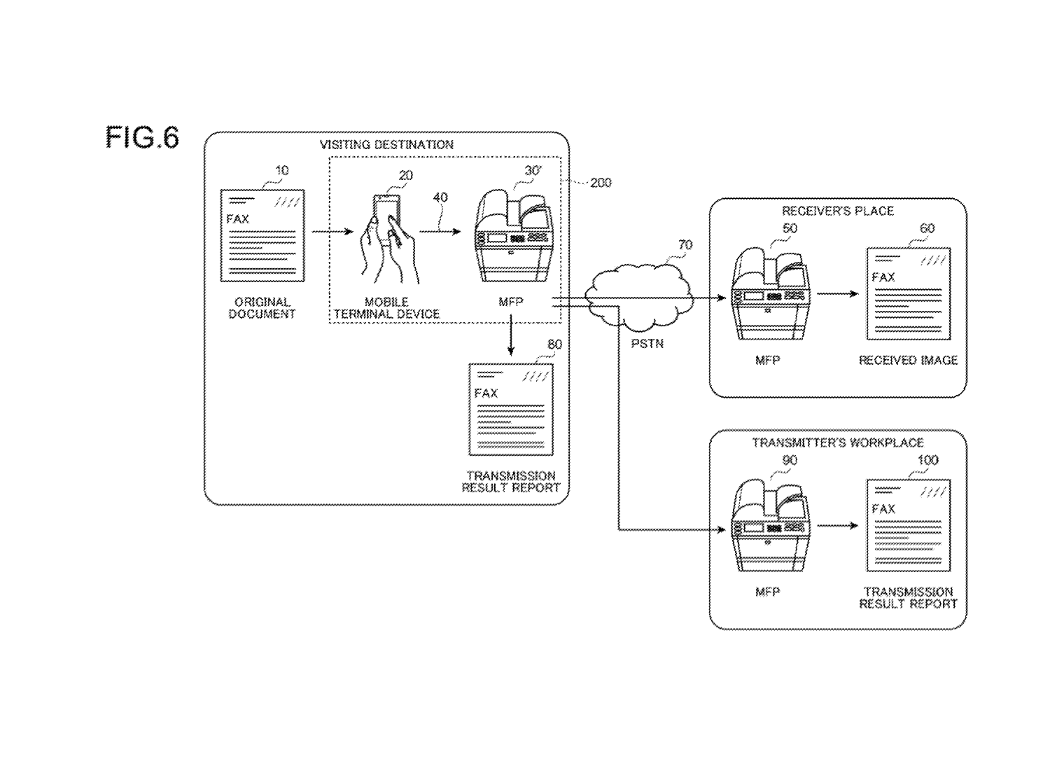

FIG. 6 is a diagram illustrating a system structure of the image transmission system 200 formed of the mobile terminal device 20 and the MFP 30′ according to the second embodiment of the invention, and also illustrating connections among the system according to the embodiment, an MFP 50 as a first address serving as a receiver of information produced with the mobile terminal device 20, and an MFP 90 as a second address serving as an output destination of a transmission result report of the information.

As shown in FIG. 6, the user of the mobile terminal device 20 can make facsimile transmission to the MFP 50 as an arbitrary receiver via the PSTL 70 using the MFP 3(1 connected to a LAN 40 from his visiting destination. The MFP 30′ is placed at the user's visiting destination, and is accessible with the user's mobile terminal device 20.

At that time., the mobile terminal device 20 acquires the original document 10 as the original image using a reading member such as, e.g., an image pickup device, a scanner, or a reader, and transmits the data to the MFP 30′ via the LAN 40. The MFP 30′ can send facsimile transmission of the image data based on the received original image data to the MFP 50 and also can output the transmission result of the facsimile transmission to the MFP 50 as the transmission result report 80. The MFP 30′ is structured to make facsimile transmission to the MFP 90 as the output destination of the transmission result report of the image data.

The structure of the MFP 30′ may be formed in the same way as that of the MFP 30 described above, so that the following description will refer mainly to different portions between the WEFT 30 and the MFP 30. In this image transmission system 200, what is different from the example of the sole use of the MFP 30 is that the settings of the first and second addresses are made on a side of the mobile terminal device 20. Accordingly, the receiver address memorizing region 325 and the transmission result report receiver address memorizing region 326 in the memory unit 32 of the MFP 30′ are structured to memorize respectively the receiver address information of the image data transmitted from the mobile terminal device 20 and the receiver address information of the transmission result report. Similarly, the image data memorizing region 324 of the memory unit 32 of the MFP 30′ is structured as the memory region memorizing the original image data transmitted from the mobile terminal device 20 and the edition result of the transmission result report.

It is to be noted that in the following description, the controller 30′ of the MFP 30′ executes the program stored in the network communication processing region 321 to execute IPP FaxOut Service (PWG 5100.15) between the MFP 30′ and the mobile terminal device 20 via the LAN 40 through controlling the network unit 37.

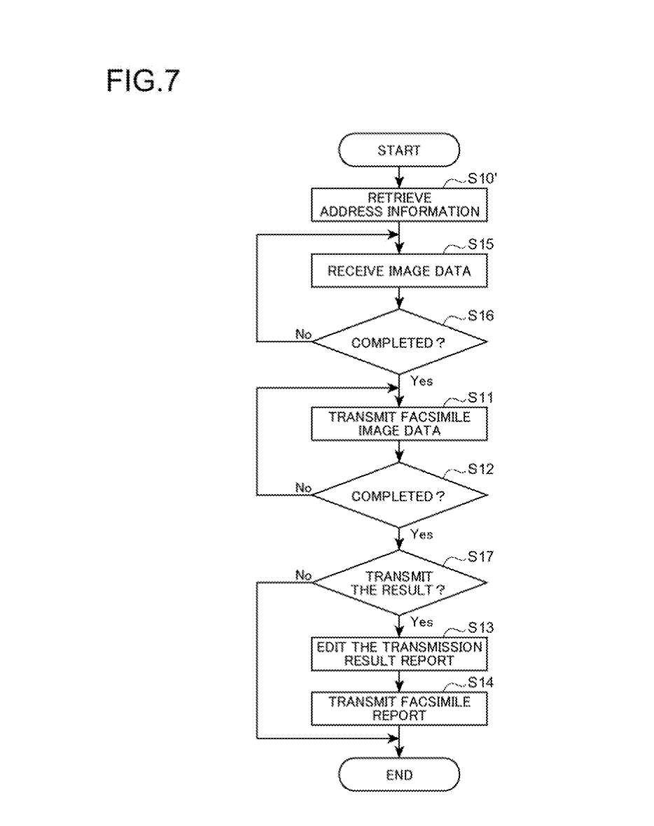

Operation of the image transmission system 200 having the above structure, shown with a flowchart in FIG. 7, is described. In FIG. 7, substantially the same steps as those in the flowchart of FIG. are assigned with the same step numbers shown in FIG. 4.

First, at Step S10′, the controller 31 acquires the receiver address information of the image data transmitted from the mobile terminal device 20 and the receiver address information of the transmission result report, and memorizes those in the receiver address memorizing region 325 and the transmission result report receiver address memorizing region 326, respectively, in the memory unit 32.

A setting of the receiver address information of the image data transmitted from the mobile terminal device 20 and the receiver address information of the transmission result report is described next. In this embodiment, the image transmission system also has a feature that a particular telephone number is judged as the receiver address information of the transmission result report when the particular telephone number is designated as the receiver address information of the transmission result report as the second address.

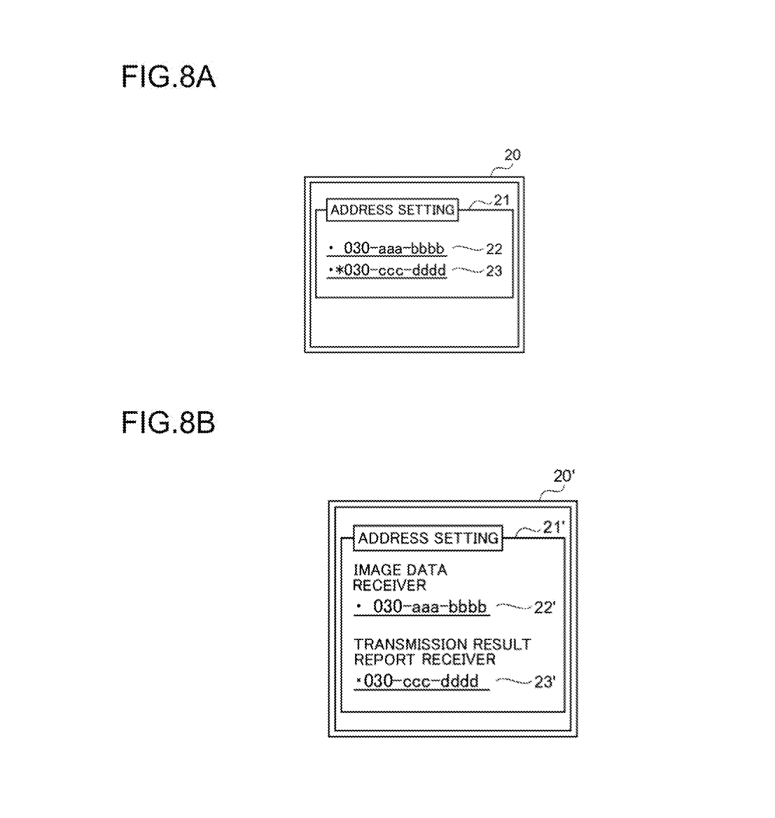

FIG. 8A shows an example of an address setting screen 21 displayed in a display device formed with the mobile terminal device 20. As shown in FIG. 8A, the user uses a ten key, not shown, of the mobile terminal device 20, and enters, e.g., “030-aaa-bbbb” as the telephone number of the MFP 50 for the receiver address information of the image data to the first address setting unit 22. Similarly, the user enters, e.g., “*030-ccc-dddd” having “*” at the head of the telephone number of the MFP 90 as the receiver address information of the transmission result report of the second address setting unit 23. The receiver address information received via the first address setting unit 22 and the second address setting unit 23 is transmitted to the MIT 30 and memorized in the receiver address memorizing region 325 and the transmission result: report receiver address memorizing region 326 in the memory unit 32, respectively.

It is to be noted that, with IPP FaxOut Service (PWG 5100.15), the mobile terminal device 20 can designate plural arbitrary addresses in use of destination-urls parameter of Create-job operation, so that the use can designate plural receivers of the image data and the transmission result report.

In this embodiment, in utilizing highly functional display capability of such mobile terminal devices, entries of the receiver address information of the image data and the receiver address information of the transmission result reports can be done with a specialized application. FIG. 8B is an illustration showing an example of the address setting screen 21′ specialized for displaying information at the display screen of the mobile terminal device 20′. As shown in FIG. 8B, the user uses a ten key, not shown, of the mobile terminal device 20′, and enters, e.g., “030-aaa-bbbb” as the telephone number of the MFP 50 for the receiver address information of the image data to the first address setting portion 22′. Similarly, the user enters, e.g., “030-ccc-dddd,” the telephone number of the MFP 90, as the receiver address information of the transmission result report of the second address setting portion 23′. Thus, the user can easily set the receiver address information of the image data and the receiver address information of the transmission result report by entering the prescribed telephone numbers to the entry boxes indicated as image data receiver and as transmission result report receiver.

Returning to FIG. 7, the control unit 31 acquiring the address information, renders the image data memorizing region 324 in the memory unit 32 memorize the original image data received from the mobile terminal device 20 by controlling the network unit 37 (Step S15).

When the reception of all of the original image data is completed (Step S16 Yes), the controller 31 makes facsimile transmission to the receiver, or namely the MFP 50, memorized in the receiver address memorizing region 325 as the image data after the original image data memorized in the image data memorizing region 324 are encoded with, e.g., ITU-T.4 (Step S11).

The controller 31 repeats the processings until the completion of the facsimile transmission of the all image data to the MFP 50, and when it is completed (Step S12 Yes), the controller 31 judges as to whether receiving the receiver address information of the transmission result report from the mobile terminal device 20. If the receiver address information of the transmission result reports is memorized in the transmission result report receiver address memorizing region 326 (Yes, at Step S17), the controller 31 edits the output contents to be outputted as the transmission result report by executing the program stored in the transmission result report edition processing region 323 (Step S13). More specifically, the controller 31 edits the transmission result report with the dot image data, and memorizes the transmission result report in the image data memorizing region 324 after encoding the data with, c.a., the standard of ITU-T.4.

The controller 31 makes facsimile transmission of the transmission result report memorized in the image data memorizing region 324 to the receiver (the MFP 90) memorized in the transmission result report receiver address memorizing region 326 (Step S14) by controlling the communication unit 36.

As described above, according to this embodiment, the user in receive the facsimile transmission of the transmission result report at the place he wants even where the user makes facsimile transmission at his visiting destination, so that he can keep the proof of the facsimile transmission in writing, and therefore the image transmission system improves utility and reliability of the apparatus.

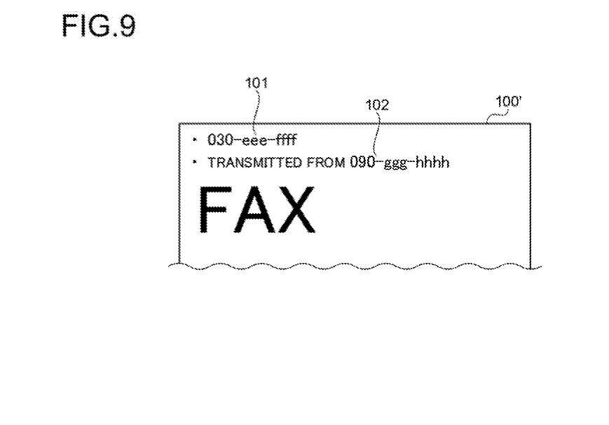

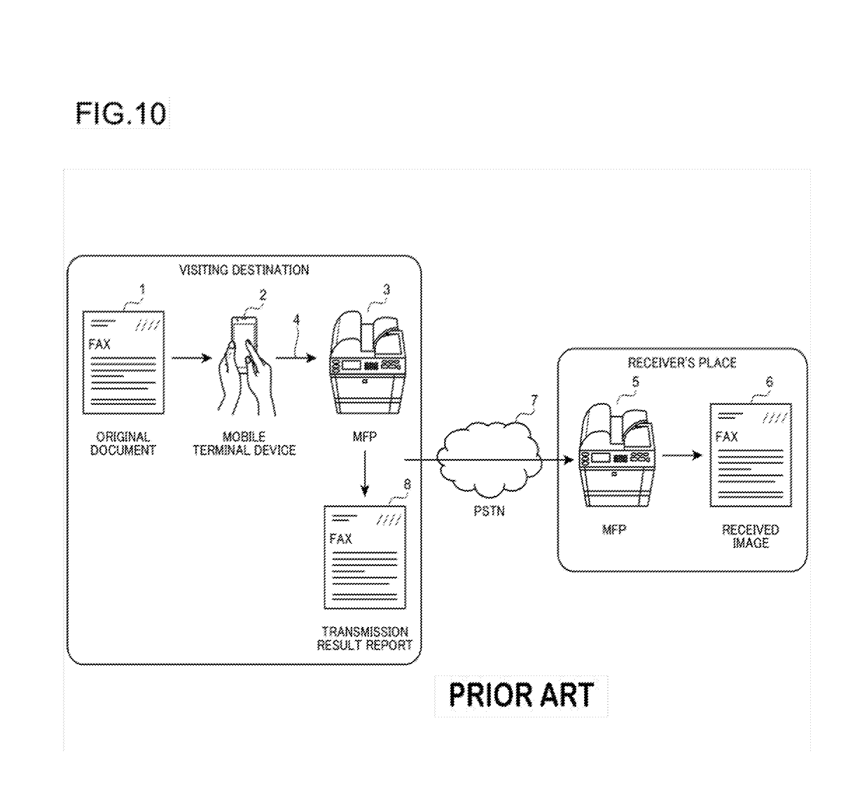

With the image transmission system 200 using the mobile terminal device 20, which mobile terminal device 20 sends the image via facsimile is readily traceable by structuring the system to output, as the transmission result report 100′, telephone number information 102 of the telephone number (090-ggg-hhhh) of the mobile terminal device 20, which is the identification information for identifying the mobile terminal device 20 making facsimile transmission via the MFP 30′, in addition to the telephone number information 101 (030-eee-ffff) of the MFP 30′ transmitting the transmission result report 100′, as shown by the example of the transmission result report in FIG. 9. It is to be noted that copying marks or icons specialized for the mobile terminal devices, instead of the telephone numbers, may be used as the identification information for identifying the mobile terminal devices 20.

With the image transmission system 200 using the mobile terminal device 20, the transmission result report edition processing may be done not on the side of the MFP 30′ but on the side of the mobile terminal device 20, and the edition result may be sent to the MFP 30′. This modified structure reduces processing loads on the side of the MFP 30′.

As described above, the mobile terminal device 20 may designate plural arbitrary addresses, and can designate the plural receivers of the image data and the plural receivers of the transmission result report, so that the User can send at one time the image data or the transmission result report to those receivers. In this situation, the image data or the transmission result report may be sent selectively only to the working MFPs by structuring the system to acquiring activation statuses, or namely, apparatus working information, of the plural designated receivers via the mobile terminal device 20 in advance.

In the embodiments, the structure that the transmission result report is sent via facsimile to the designated MFPs is described, but the invention is not limited to this, and a structure that the transmission result report is sent via email to the designated email address or addresses is possible.

This invention is applicable to any information terminal having a facsimile transmission function, such as, e.g., personal computers, and tablet computers or devices.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. An image transmission apparatus comprising:
a first address setting unit receiving a setting of a first address as a receiver of information produced with this apparatus body;
a second address setting unit for receiving a setting of a second address as an output destination of a transmission result report of the information; and
a controller controlling transmission of the information to the first address and output of the transmission result report to the second address.

2. The image transmission apparatus according to claim 1, further comprising a reading unit reading original documents,
wherein the information is image data produced by reading the original document or documents with the reading unit.

3. The image transmission apparatus according to claim 1, wherein the first and second addresses are telephone number information, and wherein the control unit judges that the telephone number information having a head portion of a prescribed identifier is the second address.

4. An image transmission system having a mobile terminal device, and an image transmission apparatus for transmitting information received from the mobile terminal device to another device, comprising:
the mobile terminal device including a first address setting unit receiving a setting of a first address as a receiver of information produced, and a second address setting unit for receiving a setting of a second address as an output destination of a transmission result report of the information; and
the image transmission apparatus including a controller control ling transmission of the information to the first address received from the mobile terminal device and output of the transmission result report to the second address.

5. The image transmission system according to claim 4, wherein the mobile terminal device has a reading unit reading an original document or documents, and wherein the information is original image data produced by reading the original document with the reading unit.

6. The image transmission system according to claim 4, wherein the image transmission apparatus encodes the original image data received from the mobile terminal device and transmits image data to the first address.

7. The image transmission system according to claim 4, wherein the first and second addresses are telephone number information, and wherein the control unit judges that the telephone number information having a head portion of a prescribed identifier is the second address.

8. The image transmission system according to claim 4, wherein the transmission result report is added with identification information, for identifying the mobile terminal device.

9. The image transmission system according to claim 4, wherein the mobile terminal device receives settings of the first address and the second address.

10. An image transmission method comprising the steps of:
processing a first address setting receiving a setting of a first address as a receiver of information;
processing a second address setting receiving a setting of a second address as output destination of a transmission, result report of the information; and
controlling transmission of the information to the first address and output of the transmission result report to the second address.
